(19) United States
(12) Patent Application Publication
(10) Pub. No.: US 2017/0171604 A1
(43) Pub. Date: Jun. 15, 2017

(54) DIGITAL TELEVISION DEVICE, SOC DECODER CHIP, AND DECODER

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Wen ZHANG, Tianjin (CN)

(21) Appl. No.: 15/250,545

(22) Filed: Aug. 29, 2016

Related U.S. Application Data
(63) Continuation of application No. PCT/CN2016/088369, filed on Jul. 4, 2016.

(30) Foreign Application Priority Data
Dec. 15, 2015 (CN) 201521054235.5

(51) Int. Cl. H04N 21/438; H04N 19/44; H04N 21/426; H04N 5/455

(52) U.S. Cl. CPC H04N 21/4382; H04N 5/455; H04N 19/44; H04N 21/42607

(57) ABSTRACT

A digital television device, an SoC decoder chip and a demodulator is disclosed. The digital television device includes a demodulator and an SoC decoder chip. The demodulator is connected to the SoC decoder chip, the demodulator processes a received signal and demodulates the received signal to a TS signal, and data transmission is carried out between the demodulator and the SoC decoder chip via a serial TS signal. According to the embodiments of the present disclosure, data transmission frequency between the demodulator and the SoC decoder chip is improved, the design difficulty of the PCB is lowered, thereby implementing Miniaturization of the module.

### CROSS REFERENCE TO RELATED APPLICATIONS

This application is a continuation of International Application No. PCT/CN2016/088369 filed on Jul. 4, 2016, which is based upon and claims priority to Chinese Patent Application No. 201521054235.5, filed before Chinese Patent Office on Dec. 15, 2015 and entitled “DIGITAL TELEVISION DEVICE, SOC DECODER CHIP, AND DECODER”, the entire contents of which are incorporated herein by reference.

### TECHNICAL FIELD

The present disclosure relates to the technical field of digital televisions, and more particularly, to a digital television device, an SoC decoder chip, and a demodulator.

### BACKGROUND

With the development of people's living standards, digital televisions are coming into people's daily life. At present, signals of a digital television are generally processed by a demodulator and a system-on-chip (SoC) decoder chip. Parallel TS data transmission is carried out between the demodulator and the SoC decoder chip. In this way, the transmission frequency is low and the parallel data transmission needs totally eight sets of data from T0 to T7, and thus more data lines are required. As a result, the design difficulty of the PCB is great, and thus it is unfavorable to miniaturization of the module.

Therefore, how to lower the design difficulty of the PCB and implement miniaturization of the module is the technical problem to be urgently solved in the related art.

### SUMMARY

In view of the above, the present disclosure provides a digital television device, an SoC decoder chip and a demodulator, which improves data transmission frequency between the demodulator and the SoC decoder chip, lowers the design difficulty of the PCB, and implements miniaturization of the module.

An embodiment of the present disclosure provides a digital television device, including a demodulator and an SoC decoder chip, wherein the demodulator is connected to the SoC decoder chip, the demodulator processes a received signal and demodulates the received signal to a TS signal, and data transmission is carried out between the demodulator and the SoC decoder chip via a serial TS signal.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram illustrating a digital television device according to some embodiments of the present disclosure;

FIG. 2 is a schematic structural diagram illustrating a demodulator in the digital television device according to some embodiments of the present disclosure;

FIG. 3 is a schematic diagram illustrating connection of an SoC decoder chip for use in the digital television device according to some embodiments of the present disclosure;

FIG. 4 is a schematic diagram illustrating connection of a demodulator for use in the digital television device according to some embodiments of the present disclosure;

FIG. 5 is a schematic structural diagram illustrating a demodulator for use in the digital television device according to some embodiments of the present disclosure; and

FIG. 6 is a schematic structural diagram illustrating specific disclosure of the digital television device according to some embodiments of the present disclosure.

### DETAILED DESCRIPTION

Embodiments of the present disclosure provide a demodulator, wherein the demodulator is connected to an SoC decoder chip, and the demodulator processes a received signal and demodulates the received signal to a digital TS signal, and data transmission is carried out between the demodulator and the SoC decoder chip via a serial TS signal. According to the embodiments of the present disclosure, data transmission frequency between the demodulator and the SoC decoder chip is improved, the design difficulty of the PCB is lowered, thereby implementing miniaturization of the module.

Nevertheless, it is not necessary to require that any technical solution according to the embodiments of the present disclosure achieves all of the above technical effects.

To make a person skilled in the art better understand the technical solutions of the embodiments of the present disclosure, the technical solutions of the present disclosure are clearly and completely described with reference to the accompanying drawings of the embodiments of the present disclosure. Apparently, the described embodiments are only a part of the embodiments of the present disclosure, rather than the entire embodiments. Based on the embodiments of the present disclosure, all other embodiments derived by persons of ordinary skill in the art without any creative efforts shall fall within the protection scope of the present disclosure.

Specific implementations of the embodiments of the present disclosure are further described hereinafter with reference to the accompanying drawings of the present disclosure.

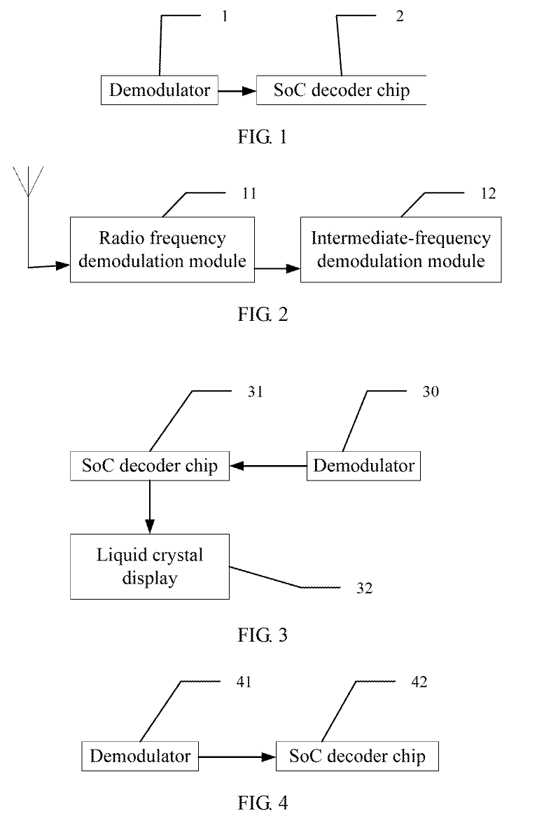

Referring to FIG. 1, an embodiment of the present disclosure provides a digital television device, including a demodulator 1 and an SoC decoder chip 2. The demodulator 1 is connected to the SoC decoder chip 2, and the demodulator 1 processes a received signal and demodulates the received signal to a digital TS signal, and data transmission is carried out between the demodulator 1 and the SoC decoder chip 2 via a serial TS signal.

Specifically, the serial TS signal is any data set from T0 to T7, and the TS signal has a transmission frequency of 1000 M, such that high-definition data transmission is satisfied.

According to the embodiments of the present disclosure, data transmission frequency between the demodulator and the SoC decoder chip is improved, the design difficulty of the PCB is lowered, thereby implementing Miniaturization of the module.

During specific implementation of the embodiments of the present disclosure, referring to FIG. 2, the demodulator 1 includes a radio frequency demodulation module 11 and an intermediate-frequency demodulation module 12, wherein the radio frequency demodulation module 11 demodulates a radio frequency signal received by an antenna to an intermediate-frequency signal, and transmits the intermediate-frequency upon demodulation to the intermediate-frequency demodulation module 12.

Specifically, the radio frequency demodulation module 11 includes a tuner which demodulates the radio frequency signal to an intermediate-frequency signal.

Referring to FIG. 3, an embodiment of the present disclosure provides an SoC decoder chip 31 for use in a digital television device, wherein the SoC decoder chip 31 is connected a demodulator 30 which processes a received signal and demodulates the received signal to a digital TS signal, and data transmission is carried out between the demodulator 30 and the SoC decoder chip 31 via a serial TS signal.

Specifically, the serial TS signal is any data set from T0 to T7, and the TS signal has a transmission frequency of 1000 M, such that high-definition data transmission is satisfied.

According to the embodiments of the present disclosure, data transmission frequency between the demodulator and the SoC decoder chip is improved, the design difficulty of the PCB is lowered, thereby implementing Miniaturization of the module.

The SoC decoder chip 31 is a core of the entire television system, the SoC decoder chip 31 is connected to a liquid crystal display 32, and the SoC decoder chip 31 decodes a received digital TS signal and converts the digital TS signal into an image signal, such that the image signal is displayed by the liquid crystal display 32.

Referring to FIG. 4, an embodiment of the present disclosure provides an SoC decoder chip 41 for use in a digital television device, wherein the demodulator 41 is connected to an SoC decoder chip 40, the demodulator 41 processes a received signal and demodulates the received signal to a digital TS signal, and data transmission is carried out between the demodulator 41 and the SoC decoder chip 40 via a serial TS signal.

Specifically, the serial TS signal is any data set from T0 to T7, and the TS signal has a transmission frequency of 1000 M, such that high-definition data transmission is satisfied.

According to the embodiments of the present disclosure, data transmission frequency between the demodulator and the SoC decoder chip is improved, the design difficulty of the PCB is lowered, thereby implementing Miniaturization of the module.

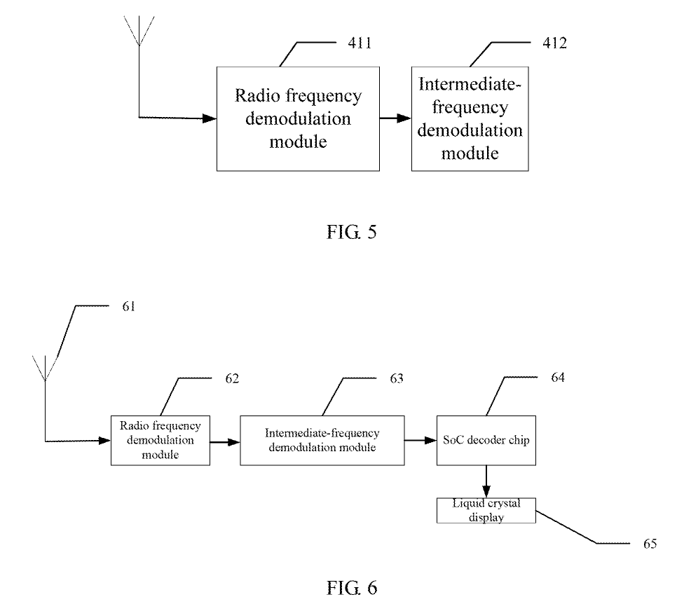

Referring to FIG. 5, the demodulator 41 includes a radio frequency demodulation module 411 and an intermediate-frequency demodulation module 412, wherein the radio frequency demodulation module 411 demodulates a radio frequency signal received by an antenna to an intermediate-frequency signal having a frequency of 5 to 8 MHz, and transmits the intermediate-frequency upon demodulation to the intermediate-frequency demodulation module 412.

Implementation of the present disclosure is further described hereinafter with reference to a specific disclosure scenario.

Referring to FIG. 6, according to an embodiment of the present disclosure, an antenna 61 receives a television signal, and a radio frequency demodulation module 62 demodulates a radio frequency signal received by the antenna 61 to an intermediate-frequency signal having a frequency of 5 to 8 MHz, and transmits the intermediate-frequency signal upon demodulation to the intermediate-frequency demodulation module 63. The intermediate-frequency demodulation module 63 is connected to an SoC decoder chip 64, and the intermediate-frequency demodulation module 63 processes a received intermediate-frequency signal and demodulates the received intermediate-frequency signal to a digital TS signal, and data transmission is carried out between the intermediate-frequency demodulation module 63 and the SoC decoder chip 64 via a serial TS signal. The SoC decoder chip 64 is a core of the entire television system, the SoC decoder chip 64 is connected to a liquid crystal display 65, and the SoC decoder chip 64 decodes a received digital TS signal and converts the digital TS signal into an image signal, such that the image signal is displayed by the liquid crystal display 65.

Specifically, the serial TS signal is any data set from T0 to T7, and the TS signal has a transmission frequency of 1000 M, such that high-definition data transmission is satisfied.

According to the embodiments of the present disclosure, data transmission frequency between the demodulator and the SoC decoder chip is improved, the design difficulty of the PCB is lowered, thereby implementing Miniaturization of the module.

Although embodiments of the present disclosure are described, those skilled in the art may make modifications and variations to these embodiments based on the basic inventive concept of the present disclosure. Therefore, the appended claims are interpreted as covering the embodiments and all such modifications and variations falling within the protection scope of the embodiments of the present disclosure. Apparently, a person skilled in the art may make various modifications and variations to the present disclosure without departing from the spirit and principles of the present disclosure. If such modifications and variations fall within the scope defined by the claims of the present disclosure and equivalent technologies thereof, the present disclosure is intended to cover such modifications and variations.

What is claimed is:

1. A digital television device, comprising a demodulator and an SoC decoder chip, wherein the demodulator is connected to the SoC decoder chip, the demodulator processes a received signal and demodulates the received signal to a TS signal, and data transmission is carried out between the demodulator and the SoC decoder chip via a serial TS signal.

2. The device according to claim 1, wherein the serial TS signal is any data set from T0 to T7.

3. The device according to claim 1, wherein the demodulator comprises a radio frequency demodulation module and an intermediate-frequency demodulation module, wherein the radio frequency demodulation module demodulates a radio frequency signal received by an antenna to an intermediate-frequency signal, and transmits the intermediate-frequency upon demodulation to the intermediate-frequency demodulation module.

4. The device according to claim 3, wherein the radio frequency module comprises a tuner which demodulates the radio frequency to an intermediate-frequency signal.

5. A SoC decoder chip for use in a digital television device, wherein the SoC decoder chip is connected a demodulator which processes a received signal and demodulates the received signal to a digital TS signal, and data transmission is carried out between the demodulator and the SoC decoder chip via a serial TS signal.

6. The decoder chip according to claim 5, wherein the serial TS signal is any data set from T0 to T7.

7. The decoder chip according to claim 5, wherein the SoC decoder chip is connected to a liquid crystal display, the SoC decoder chip decodes the received digital TS signal, converts the digital TS signal to an image signal, and displays the image signal via the liquid crystal display.

8. A demodulator for use in a digital television device, wherein the demodulator is connected to an SoC decoder chip, and the demodulator processes a received signal and demodulates the received signal to a digital TS signal, and data transmission is carried out between the demodulator and the SoC decoder chip via a serial TS signal.

9. The decoder according to claim 8, wherein the serial TS signal is any data set from T0 to T7.

10. The decoder according to claim 8, wherein the demodulator comprises a radio frequency demodulation module and an intermediate-frequency demodulation module, wherein the radio frequency demodulation module demodulates a radio frequency signal received by an antenna to an intermediate-frequency signal, and transmits the intermediate-frequency upon demodulation to the intermediate-frequency demodulation module.
